(19) United States
(12) Patent Application Publication
(10) Pub. No.: US 2017/0314422 A1
(43) Pub. Date: Nov. 2, 2017

(54) Engine Exhaust and Cooling System for Power Production

(71) Applicant: Tao Song, LaSalle (CA)

(72) Inventor: Tao Song, LaSalle (CA)

(21) Appl. No.: 15/139,691

(22) Filed: Apr. 27, 2016

(51) Int. Cl. F01K 15/00; F01N 5/02; F01K 13/00; H02K 7/18; F01K 11/02

(52) U.S. Cl. CPC F01K 15/00; H02K 7/1823; F01K 11/02; F01K 13/006; F01N 5/02

(57) ABSTRACT

He is disclosed a heat scavenging system for recapturing waste heat from an internal combustion engine having a water cooling system and an exhaust system. The heat scavenging system includes a first cooling stream coupled to the exhaust system for transferring heat from the exhaust system and converting it into a first high pressure gas stream for driving a first turbine coupled to a first electric generator. The system further includes a second cooling stream coupled to the water cooling system for converting heat from the water cooling system into a second high pressure gas stream for driving a second turbine coupled to a second electric generator. The first and second electric generators effectively convert the waste heat from the internal combustion engine into electrical energy.

### CROSS REFERENCE TO RELATED APPLICATION

This application claims priority from U.S. provisional application 62/166,200 filed May 26, 2015 the entirety of which is incorporated herein by reference.

### FIELD OF THE INVENTION

The invention relates generally to the field of internal combustion engines, and in particular, to internal combustion engines having cooling systems adapted to extract additional energy from the engine.

### BACKGROUND OF THE INVENTION

Internal combustion engines as used in cars and the like convert a hydrocarbon fuel, such as gasoline into kinetic engine. A great deal of waste heat is produced in the process. A significant portion of this waste heat exits the engine in the form of heated exhaust gas which passes through the exhaust system. The exhaust system consists of a series of elongated metal pipes which terminate in an open tail pipe which evacuates to the atmosphere. A significant amount of the waste heat actually heats up the internal parts of the internal combustion engine. In order to keep the internal combustion engine operating efficiently, the waste heat in the internal parts of the engine must be disposed of via a cooling system. The cooling system usually consists of a series of sealed passages through the engine block coupled to a water pump and to a radiator by a series of radiator houses. Water is passed through the engine block through the cooling system to transfer the heat from the engine block to the radiator. Therefore, a majority of the waste heat generated by the internal combustion engine is simply vented to the atmosphere through the exhaust system and through the radiator. A system which recaptures this waste heat and transforms it into useful energy would increase the energy efficiency of the engine.

### SUMMARY OF THE INVENTION

In accordance with one aspect of the present invention, there is provided a heat scavenging system for recapturing waste heat from an internal combustion engine having a water cooling system and an exhaust system. The heat scavenging system includes a first cooling stream coupled to the exhaust system for transferring heat from the exhaust system and converting it into a first high pressure gas stream for driving a first turbine coupled to a first electric generator. The system further includes a second cooling stream coupled to the water cooling system for converting heat from the water cooling system into a second high pressure gas stream for driving a second turbine coupled to a second electric generator. The first and second electric generators effectively convert the waste heat from the internal combustion engine into electrical energy.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of an engine and exhaust cooling system for power production made in accordance with the present invention.

In the drawings like characters of reference indicate corresponding parts in the different figures.

### DETAILED DESCRIPTION OF THE INVENTION

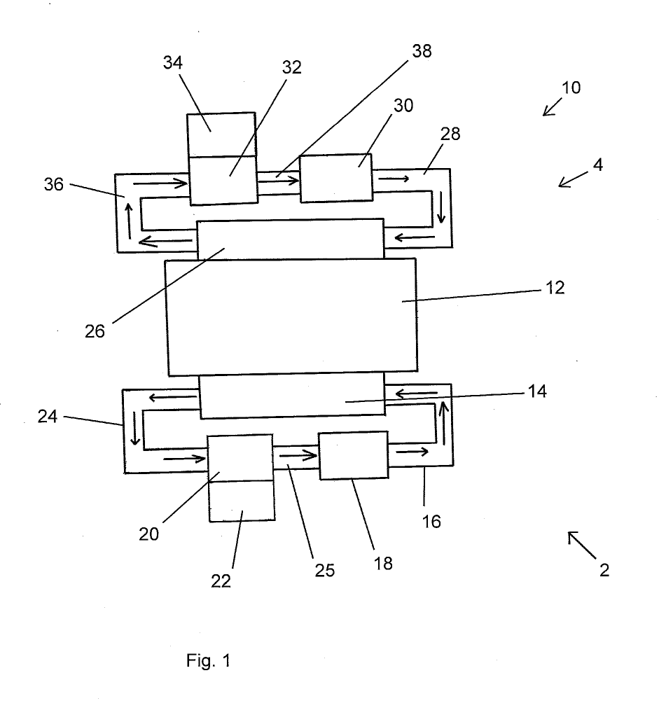

Referring firstly to FIG. 1, the system of the present invention, shown generally as item 10, includes an exhaust heat retrieval subsystem, shown generally as item 2, and an engine water cooling subsystem, shown generally as item 4. Both subsystems 2 and 4 are configured to convert recaptured heat from engine 12 and convert it into electricity while cooling the engine and exhaust.

Exhaust heat retrieval subsystem 2 consists of an exhaust header 14 where the exhaust gases pass from the engine before proceeding to the muffler and tail pipe. Exhaust header 14 consists of a first heat exchanger isolating two separate streams, one for the hot exhaust gas from the engine, and a first cooling fluid stream. Preferably the two separate streams are arranged in a counter current arrangement to maximize the heat transfer from the hotter exhaust stream to the cooler first cooling fluid stream. The first cooling fluid stream enters header 14 via low pressure (low temperature) conduit 16, and exits header 14 via high pressure conduit 24. High pressure conduit 24 is coupled to turbine 20 so that the first cooling fluid stream passes through the turbine and then to radiator 18 via conduit 25. Radiator 18 is configured to cool and condense the first cooling fluid stream and pass it to low pressure conduit 16. The first cooling fluid stream enters header 14 as a cool liquid at relatively low pressure. Upon passing through header 14, heat is transferred from the exhaust stream to the first cooling fluid stream and causing a phase change in the fluid to convert it into a hot high pressure gas which enters conduit 24. This hot high pressure gas passes to turbine 20 which, being coupled to generator 22, converts some of the energy from the hot gas into electricity. The first cooling fluid stream then passes to radiator 18 where it is cooled and condensed back into a cool liquid when it enters conduit 16. In this way, some of the energy which would ordinarily be wasted to the atmosphere via the engine's exhaust system is recaptured as electricity.

Engine cooling subsystem 4 consists of a cooling header 26 coupled to a low pressure conduit 28 which is in turn coupled to radiator 30, turbine 32 and high pressure conduit 36. Header 26 consists of a heat exchanger isolating two fluids, namely an engine water cooler stream directly from the engine and a second fluid cooling stream. The engine water cooler stream is essentially a standard water cooled engine cooling system without the radiator portion. In place of the standard radiator in the engine cooler, header 26 is present to exchange heat from the engine water cooler stream to the second fluid cooling stream. Again, preferably the two streams are arranged in a counter current arrangement to maximize the exchange of heat between the two streams.

The second fluid cooling stream enters header 26 as a cool, low pressure liquid. As it passes through header 26, the second fluid cooling stream is heated into a hot high pressure gas and enters high pressure conduit 36. The heated high pressure gas then passes to turbine 32 which, being coupled to generator 34, converts some of the energy in the heated high pressure gas to electricity. The fluid then passes to radiator 30 by conduit 38. At radiator 30, the second fluid cooling stream cools and condenses back into a low pressure liquid. In this way, some of the engine heat which would just be wasted through a conventional engine radiator is recaptured by turbine 32 and converted into electricity by generator 34.

The first and second fluid cooling streams are preferably separate streams of heat exchange fluid. Theoretically, any suitable fluid can be used, such as water. Ideally, the fluid used for the streams should be selected to ensure that a phase change can occur at the desired operating temperatures and pressures. Several suitable fluids such as Freon, CFCs, ammonia or other commercially available refrigerants or heat exchange working fluids may be used. Of course, the various heat exchangers, conduits and radiators are all sealed together to ensure that the heat exchange fluids do not leak.

The present invention has the advantage of significantly increasing the energy efficiency of the engine by recapturing waste heat and using the recaptured energy to generate electricity. If the system is made efficient enough, the electricity generated from generators 22 and 34 could be sufficient to replace the engine's alternator.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A heat scavenging system for recapturing waste heat from an internal combustion engine having a water cooling system and an exhaust system, the heat scavenging system comprising a first cooling stream coupled to the exhaust system for transferring heat from the exhaust system and converting it into a first high pressure gas stream for driving a first turbine coupled to a first electric generator, and a second cooling stream coupled to the water cooling system for converting heat from the water cooling system into a second high pressure gas stream for driving a second turbine coupled to a second electric generator.

2. The heat scavenging system of claim 1 wherein the first cooling stream comprises a first heat exchanger coupled to the exhaust system, the first heat exchanger having a low pressure inlet and a high pressure outlet, a first radiator having an high temperature inlet and a low temperature outlet, the first turbine having a high pressure inlet and a lower pressure outlet, the high pressure outlet of the first heat exchanger being coupled to the high pressure inlet of the first turbine by a first high pressure conduit, the high temperature inlet of the first radiator being coupled to the lower pressure outlet of the first turbine by a first high temperature conduit, the low pressure inlet of the first heat exchanger being coupled to the low temperature outlet of the first radiator by a first low temperature conduit, and wherein the first heat exchanger, first turbine, first radiator, first high pressure conduit, first high temperature conduit and first low temperature conduit are all sealed together to prevent leakage of a first working fluid adapted to transfer heat energy from the exhaust system to the first electric generator.

3. The heat scavenging system of claim 1 wherein the second cooling stream comprises a second heat exchanger coupled to the water cooling system, the second heat exchanger having a low pressure inlet and a high pressure outlet, a second radiator having an high temperature inlet and a low temperature outlet, the second turbine having a high pressure inlet and a lower pressure outlet, the high pressure outlet of the second heat exchanger being coupled to the high pressure inlet of the second turbine by a second high pressure conduit, the high temperature inlet of the second radiator being coupled to the lower pressure outlet of the second turbine by a second high temperature conduit, the low pressure inlet of the second heat exchanger being coupled to the low temperature outlet of the second radiator by a second low temperature conduit, and wherein the second heat exchanger, second turbine, second radiator, second high pressure conduit, first high temperature conduit and first low temperature conduit are all sealed together to prevent leakage of a second working fluid adapted to transfer heat energy from the water cooling system to the second electric generator.

4. The heat scavenging system of claim 2 wherein the second cooling stream comprises a second heat exchanger coupled to the water cooling system, the second heat exchanger having a low pressure inlet and a high pressure outlet, a second radiator having an high temperature inlet and a low temperature outlet, the second turbine having a high pressure inlet and a lower pressure outlet, the high pressure outlet of the second heat exchanger being coupled to the high pressure inlet of the second turbine by a second high pressure conduit, the high temperature inlet of the second radiator being coupled to the lower pressure outlet of the second turbine by a second high temperature conduit, the low pressure inlet of the second heat exchanger being coupled to the low temperature outlet of the second radiator by a second low temperature conduit, and wherein the second heat exchanger, second turbine, second radiator, second high pressure conduit, first high temperature conduit and first low temperature conduit are all sealed together to prevent leakage of a second working fluid adapted to transfer heat energy from the water cooling system to the second electric generator.

5. A heat scavenging system for recapturing waste heat from an internal combustion engine having a water cooling system and an exhaust system, the system comprising:
a. A first heat exchanger coupled to the exhaust system, the first heat exchanger having a low pressure inlet and a high pressure outlet;
b. a first radiator having an high temperature inlet and a low temperature outlet;
c. a first turbine having a high pressure inlet and a lower pressure outlet;
d. a first electric generator coupled to the first turbine;
e. the high pressure outlet of the first heat exchanger being coupled to the high pressure inlet of the first turbine by a first high pressure conduit;
f. the high temperature inlet of the first radiator being coupled to a lower pressure outlet of the first turbine by a first high temperature conduit;
g. the low pressure inlet of the first heat exchanger being coupled to the low temperature outlet of the first radiator by a first low temperature conduit;
h. the first heat exchanger, first turbine, first radiator, first high pressure conduit, first high temperature conduit and first low temperature conduit all being sealed to prevent leakage of a first working fluid adapted to transfer heat energy from the exhaust system to the first electric generator,
i. A second heat exchanger coupled to the water cooling system, the second heat exchanger having a low pressure inlet and a high pressure outlet;
j. a second radiator having an high temperature inlet and a low temperature outlet;
k. a second turbine having a high pressure inlet and a lower pressure outlet;
l. a second electric generator coupled to the second turbine;
m. the high pressure outlet of the second heat exchanger being coupled to the high pressure inlet of the second turbine by a second high pressure conduit;
n. the high temperature inlet of the second radiator being coupled to a lower pressure outlet of the second turbine by a second high temperature conduit;
o. the low pressure inlet of the second heat exchanger being coupled to the low temperature outlet of the first radiator by a first low temperature conduit, and
p. the second heat exchanger, second turbine, second radiator, second high pressure conduit, second high temperature conduit and second low temperature conduit all being sealed to prevent leakage of a second working fluid adapted to transfer heat energy from the cooling system to the second electric generator.
